(19) United States
(12) Patent Application Publication
(10) Pub. No.: US 2020/0319047 A1
(43) Pub. Date: Oct. 8, 2020

(54) High Pressure Gauge

(71) Applicant: Chin Ray Industrial Ltd., Shuishang Township (TW)

(72) Inventor: Chiu-Sung Chou, Shuishang Township (TW)

(21) Appl. No.: 16/907,470

(22) Filed: Jun. 22, 2020

Related U.S. Application Data
(63) Continuation-in-part of application No. 15/871,337, filed on Jan. 15, 2018.

(51) Int. Cl. G01L 7/16

(52) U.S. Cl. CPC G01L 7/163; G01L 7/166

(57) ABSTRACT

A high pressure gauge contains: a body, a support, a film, a cylinder, an indicator, a screw element, a stud, and a push post. The stud has a channel through which the push post passes, and the stud has a seal ring contacting with the push post in the channel. A central disc is defined between the film and a circular tab of the screw element, the central disc contacts with the film, the push post includes a C retainer engaged on an extension of the push post, and the C retainer is defined between the screw element and the stud. When the push post moves, the C retainer abuts against the stud, and an auxiliary ring is received in the channel, located above and contacts with the seal ring and the extension of the push post. The seal ring is concave, and the auxiliary ring is convex.

### FIELD OF THE INVENTION

This application is a Continuation-in-Part of application Ser. No 15/871,337, filed on Jan. 15, 2018.

### BACKGROUND OF THE INVENTION

### Description of the Prior Art

A conventional pressure gauge is applied to measure a pressure value of an object.

When a push post abuts against the film, a central position of the film is pulled unevenly to reduce a measuring accuracy and a removal of the push post.

When providing a seal ring, the seal ring influences a movement of the push post to reduce the measuring accuracy.

The present invention has arisen to mitigate and/or obviate the afore-described disadvantages.

### SUMMARY OF THE INVENTION

One aspect of the present invention is to provide a high pressure gauge which contains a film and a central disc contacting with the film, thus evenly exerting force to push the film and to measure an object accurately.

Further aspect of the present invention is to provide a high pressure gauge which the object is removed from the stud after being measured, the C retainer in the support contacts with a top of the stud to stop a removal of the push post from the stud.

Another aspect of the present invention is to provide a high pressure gauge which the auxiliary ring is defined between the channel and the seal ring and is concave, the auxiliary ring is convex to be inserted to the seal ring, and the seal ring is forced by the auxiliary ring to reduce the contact area of the seal ring with the push post, thus reducing friction of the seal ring with the push post.

To obtain the above aspects, a high pressure gauge provided by the present invention contains: a body, a support connected with a bottom of the body, a film defined between the body and the support, a cylinder contacting with and located on the film, an indicator mounted on the cylinder, a screw element screwed with and located below the bottom of the cylinder, a stud connected with a bottom of the support, and a push post passing through the stud to abut against the screw element.

The stud has a channel through which the push post passes, and the stud has a seal ring received in the channel and contacting with the push post. A central disc is defined between a bottom of the film and a circular tab of the screw element, the central disc is made of deformable material and contacts with the film, the push post includes a C retainer engaged on an extension of the push post, and the C retainer is defined between the screw element and the stud. When the push post moves, the C retainer abuts against the stud, an auxiliary ring is received in the channel, located above and contacts with the seal ring and the extension of the push post. The auxiliary ring is made of wear-resistant hard material, the seal ring is concave, and the auxiliary ring is convex, such that when the auxiliary ring is inserted to the seal ring, the seal ring is forced by the auxiliary ring to reduce a contact area of the seal ring with the push post.

### BRIEF DESCRIPTION OF THE DRAWINGS

FIG. 1 is a cross-sectional perspective view showing the assembly of a part of a high pressure gauge according to a preferred embodiment of the present invention.

FIG. 2 is a cross-sectional perspective view showing a part of the assembly of the high pressure gauge according to the preferred embodiment of the present invention.

FIG. 3 is another cross-sectional perspective view showing a part of the assembly of the high pressure gauge according to the preferred embodiment of the present invention.

FIG. 4 is a cross-sectional perspective view showing the operation of a part of the high pressure gauge according to the preferred embodiment of the present invention.

### DETAILED DESCRIPTION OF THE PREFERRED EMBODIMENTS

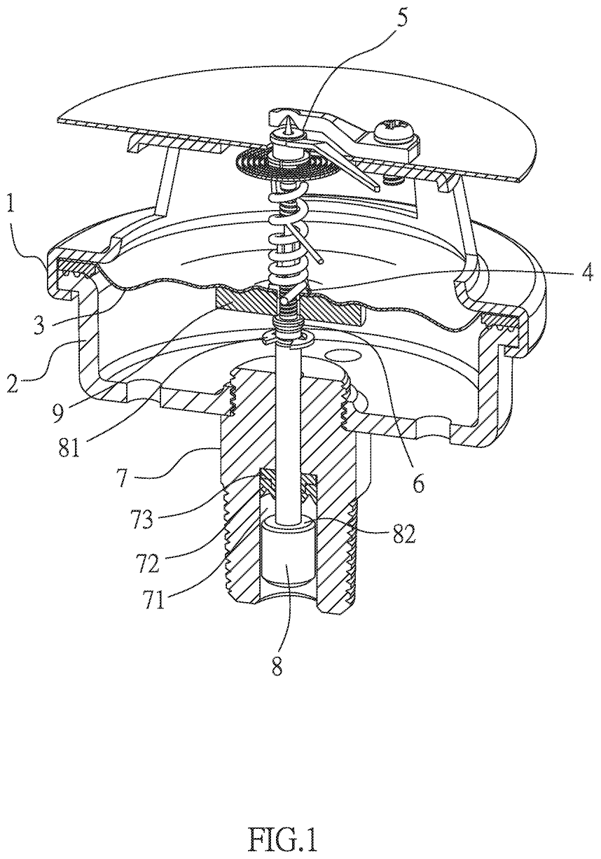

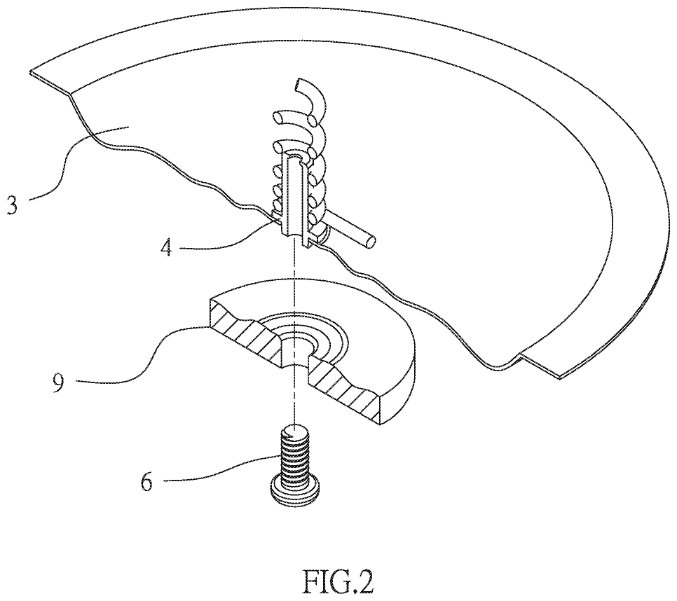

With reference to FIGS. 1 and 2, a high pressure gauge according to a preferred embodiment of the present invention comprises: a body 1, a support 2 connected with a bottom of the body 1, a film 3 defined between the body 1 and the support 2, a cylinder 4 contacting with and located on the film 3, an indicator 5 mounted on the cylinder 4, a screw element 6 screwed with and located below the bottom of the cylinder 4, a stud 7 connected with a bottom of the support 2, and a push post 8 passing through the stud 7 to abut against the screw element 6, wherein the stud 7 has a channel 71 through which the push post 8 passes, and the stud 7 has a seal ring 72 received in the channel 71 and contacting with the push post 8.

A central disc 9 is defined between a bottom of the film 3 and a circular tab of the screw element 6, wherein the central disc 9 is made of deformable material and contacts with the film 3. The push post 8 includes a C retainer 81 engaged on an extension of the push post 8, and the C retainer 81 is defined between the screw element 6 and the stud 7. When the push post 8 moves, the C retainer 81 abuts against the stud 7, an auxiliary ring 73 is received in the channel 71, located above and contacts with the seal ring 72 and the extension of the push post 8, wherein the auxiliary ring 73 is made of wear-resistant hard material, the seal ring 72 is concave, and the auxiliary ring 73 is convex, such that when the auxiliary ring 73 is inserted to the seal ring 72, the seal ring 72 is forced by the auxiliary ring 73 to reduce a contact area of the seal ring 72 with the push post 8, thus contacting the seal ring 72 with the push post 8 smoothly.

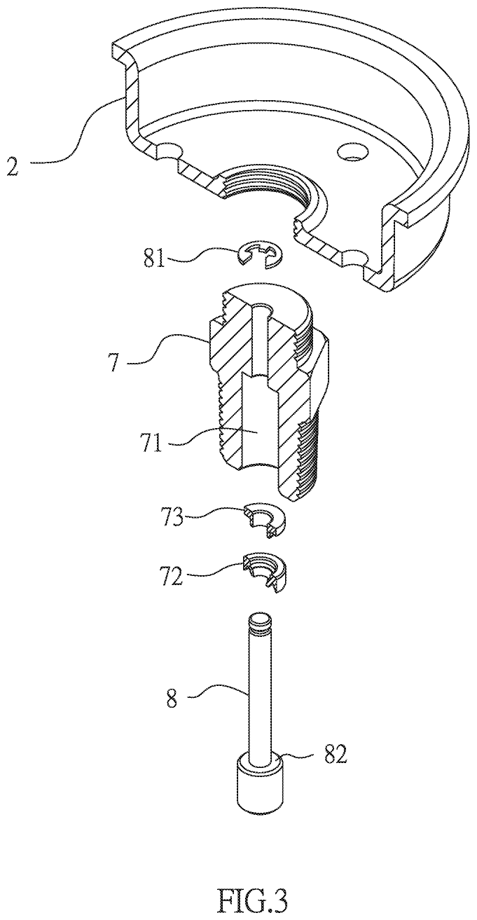

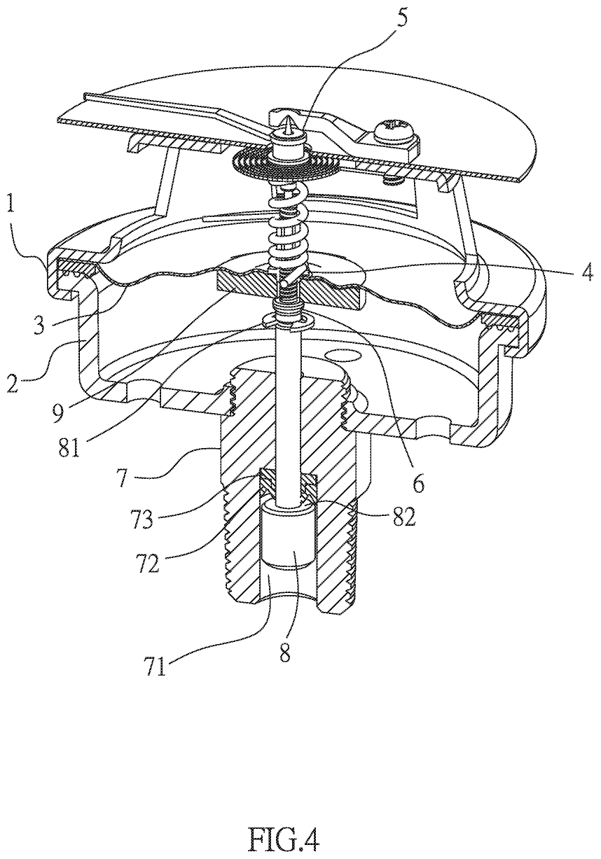

Referring to FIGS. 3-4, an object is connected on the stud 7 to push the push post 8 to urge the screw element 6 via the channel 71 of the stud 7, and the circular tab of the screw element 6 is purged by the push post 8 to actuate the circular disc 9 to push the film 3 upward, wherein the central disc 9 is made of the deformable material to matingly contact with the film 3, and the film 3 acts on the indicator 5, thus measuring the object accurately.

When measuring the object, the object acts onto the push post 8, the seal ring 72 contacts with a protrusion 82 of the push post 8 to avoid the object contacting with components of the indicator, thus maintaining measuring precision of the indicator.

The auxiliary ring 73 is defined between the channel 71 and the seal ring 72 and is concave, the auxiliary ring 73 is convex to be inserted to the seal ring 72, and the seal ring 72 is forced by the auxiliary ring 73 to reduce the contact area of the seal ring 72 with the push post 8, thus reducing friction of the seal ring 72 with the push post 8, prolonging a service life of the seal ring 72, and enhancing the measuring precision of the indicator.

The object is removed from the stud 7 after being measured, and the push post 8 detaches from the screw element 6 so that the indicator 5 recovers an original state (i.e. not measuring the object), and the push post 8 further removes a distance from the stud 7 so that the C retainer 81 in the support 2 contacts with a top of the stud 7 to stop a removal of the push post 8 from the stud 7.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. A high pressure gauge comprising: a body, a support connected with a bottom of the body, a film defined between the body and the support, a cylinder contacting with and located on the film, an indicator mounted on the cylinder, a screw element screwed with and located below the bottom of the cylinder, a stud connected with a bottom of the support, and a push post passing through the stud to abut against the screw element, wherein the stud has a channel through which the push post passes, and the stud has a seal ring received in the channel and contacting with the push post, wherein a central disc is defined between a bottom of the film and a circular tab of the screw element, the central disc is made of deformable material and contacts with the film, the push post includes a C retainer engaged on an extension of the push post, and the C retainer is defined between the screw element and the stud, when the push post moves, the C retainer abuts against the stud, an auxiliary ring is received in the channel, located above and contacts with the seal ring and the extension of the push post, wherein the auxiliary ring is made of wear-resistant hard material, the seal ring is concave, and the auxiliary ring is convex, such that when the auxiliary ring is inserted to the seal ring, the seal ring is forced by the auxiliary ring to reduce a contact area of the seal ring with the push post.
